(19) United States
(12) Patent Application Publication
(10) Pub. No.: US 2025/0336605 A1
(43) Pub. Date: Oct. 30, 2025

(54) MULTILAYER CERAMIC CAPACITOR

(71) Applicant: Murata Manufacturing Co., Ltd., Nagaokakyo-shi (JP)

(72) Inventor: Toshihiko KOBAYASHI, Nagaokakyo-shi (JP)

(21) Appl. No.: 19/260,781

(22) Filed: Jul. 7, 2025

Related U.S. Application Data
(63) Continuation of application No. PCT/JP2024/015286, filed on Apr. 17, 2024.

(30) Foreign Application Priority Data
Jun. 21, 2023 (JP) 2023-101656

(51) Int. Cl. H01G 4/232; H01G 4/008; H01G 4/012; H01G 4/30

(52) U.S. Cl. CPC H01G 4/2325; H01G 4/008; H01G 4/012; H01G 4/30

(57) ABSTRACT

In a multilayer ceramic capacitor, an outer electrode includes at least one of barium-boron-silicon-based glass, strontium-boron-silicon-based glass, or barium-strontium-boron-silicon-based glass, which serves as glass, and copper, the glass and the copper being exposed at a surface of the outer electrode, a sulfur-including layer is provided on at least a portion of the surface of the glass exposed at the surface of the outer electrode, and a tin layer is provided on at least a portion of the surface of the copper exposed at the surface of the outer electrode.

### CROSS REFERENCE TO RELATED APPLICATIONS

This application claims the benefit of priority to Japanese Patent Application No. 2023-101656 filed on Jun. 21, 2023 and is a Continuation Application of PCT Application No. PCT/JP2024/015286 filed on Apr. 17, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

A plating film may be arranged on the surface of an outer electrode of a multilayer ceramic capacitor to improve the wettability of solder when the multilayer ceramic capacitor is mounted. When the plating film is formed, in general, a plating solution is used. Japanese Unexamined Patent Application Publication No. 2020-72246 discloses that a sulfur-including layer is arranged in an outer electrode to suppress the reliability from deteriorating due to a plating solution.

### SUMMARY OF THE INVENTION

However, in the related art, the reliability of the multilayer ceramic capacitor is not sufficiently prevented from deteriorating. In the related art, during the step of forming a plating film, a glass material included in the outer electrode may be dissolved. In addition, hydrogen may diffuse into the outer electrode. Dissolution of the glass material and diffusion of hydrogen into the outer electrode causes deterioration of the reliability of the multilayer ceramic capacitor.

Accordingly, example embodiments of the present invention provide multilayer ceramic capacitors having more improved reliability.

A multilayer ceramic capacitor according to an example embodiment of the present invention includes a ceramic element body including a plurality of stacked dielectric layers and a plurality of stacked inner electrode layers and including six surfaces including a first principal surface and a second principal surface that oppose each other in a height direction, a first side surface and a second side surface that oppose each other in a width direction orthogonal to the height direction, and a first end surface and a second end surface that oppose each other in a length direction orthogonal to the height direction and the width direction and an outer electrode disposed on the ceramic element body and connected to a portion of the inner electrode layers, wherein the outer electrode includes at least one of barium-boron-silicon-based glass, strontium-boron-silicon-based glass, or barium-strontium-boron-silicon-based glass, which serves as glass, and copper, the glass and the copper are exposed at a surface of the outer electrode, a sulfur-including layer is located on at least a portion of the surface of the glass exposed at the surface of the outer electrode, and a tin layer is located on at least a portion of the surface of a copper exposed at the surface of the outer electrode.

According to example embodiments of the present invention, multilayer ceramic capacitors achieving more improved reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to the present example embodiment of the present invention.

FIG. 2 is a sectional view of the cross section taken along line I-I in FIG. 1.

FIG. 3 is a sectional view of the cross section taken along line II-II in FIG. 1.

FIG. 4 is an enlarged view of a portion illustrated in a box in FIG. 2.

FIG. 5 is a diagram illustrating the results of Examples and Comparative examples.

### DETAILED DESCRIPTION OF THE EXAMPLE EMBODIMENTS

### Multilayer Ceramic Capacitor

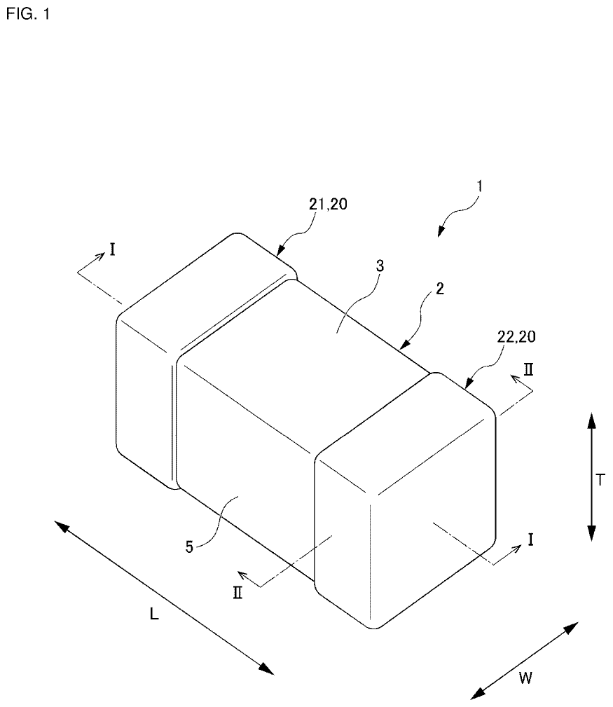

An example embodiment according to the present invention will be described with reference to FIG. 1. FIG. 1 is a perspective view of a multilayer ceramic capacitor 1 according to the present example embodiment. FIG. 1 illustrates a two-terminal multilayer ceramic capacitor. The multilayer ceramic capacitor 1 according to an example embodiment of the present invention is not limited to the two-terminal multilayer ceramic capacitor. The multilayer ceramic capacitor 1 according to an example embodiment of the present invention may be a multi-terminal multilayer ceramic capacitor, such as a three-terminal multilayer ceramic capacitor.

The multilayer ceramic capacitor 1 includes a ceramic element body 2 and a terminal electrode 20. The terminal electrode 20 includes a first terminal electrode 21 and a second terminal electrode 22.

### Ceramic Element Body

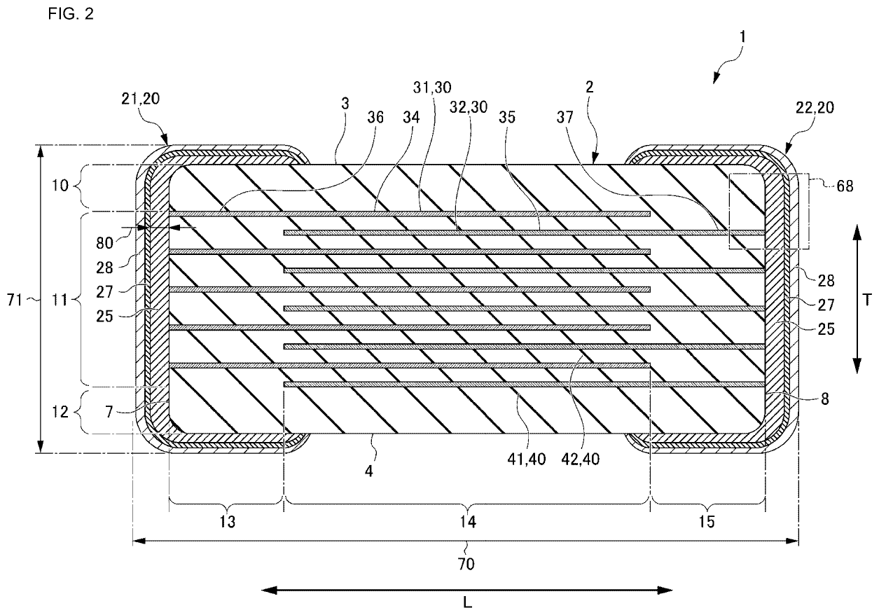

The ceramic element body 2 includes a plurality of stacked dielectric layers 40 and a plurality of stacked inner electrode layers 30. The dielectric layers 40 and the inner electrode layers 30 are illustrated in FIG. 2. The shape of the ceramic element body 2 is a rectangular or substantially rectangular parallelepiped shape.

Regarding the ceramic element body 2, the direction in which the dielectric layers 40 and the inner electrode layers 30 are stacked is set to be a height direction T. A direction orthogonal to the height direction is set to be a width direction W. A direction orthogonal to the height direction T and the width direction W is set to be a length direction L.

In the ceramic element body 2, one surface of two surfaces that oppose each other in the height direction T is set to be a first principal surface 3. The other surface is set to be a second principal surface 4. In the ceramic element body 2, one surface of two surfaces that oppose each other in the width direction W is set to be a first side surface 5. The other surface is set to be a second side surface 6. In the ceramic element body 2, one surface of two surfaces that oppose each other in the length direction L is set to be a first end surface 7. The other surface is set to be a second end surface 8.

Regarding a cross section of the ceramic element body 2, a line I-I cross section in FIG. 1 is referred to as an LT cross section. Regarding a cross section of the ceramic element body 2, a line II-II cross section in FIG. 1 is referred to as a WT cross section.

A portion at which three surfaces of the ceramic element body 2 intersect with each other is referred to as a corner portion of the ceramic element body 2. A portion at which two surfaces of the ceramic element body 2 intersect with each other is referred to as a ridge portion of the ceramic element body 2. It is preferable that the corner portion and the ridge portion be provided with roundness.

### Dielectric Layer

A main material for forming the dielectric layer 40 is a ceramic material. Examples of the ceramic material include dielectric ceramics including barium titanate, calcium titanate, strontium titanate, or calcium zirconate as a primary component. The ceramic material may be a dielectric ceramic in which a secondary component, such as a manganese compound, an iron compound, a chromium compound, a cobalt compound, or a nickel compound, is added to the primary component.

The division in the length direction L of the ceramic element body 2 will be described with reference to FIG. 2. FIG. 2 is a sectional view of the cross section taken along line I-I in FIG. 1. The ceramic element body 2 can be divided into a first-principal-surface-side outer layer portion 10, an effective portion 11, and a second-principal-surface-side outer layer portion 12 in the height direction T.

The first-principal-surface-side outer layer portion 10 is a portion between the inner electrode layer 30 nearest to the first principal surface 3 and the first principal surface 3. The effective portion 11 is a portion in which an inner electrode layer 30 opposes an inner electrode layer 30. The second-principal-surface-side outer layer portion 12 is a portion between the inner electrode layer 30 nearest to the second principal surface 4 and the second principal surface 4.

Of the dielectric layers 40, the dielectric layer 40 arranged in the first-principal-surface-side outer layer portion 10 or the second-principal-surface-side outer layer portion 12 is referred to as an outer-layer dielectric layer 41. Of the dielectric layers 40, the dielectric layer 40 arranged in the effective portion 11 is referred to as an inner-layer dielectric layer 42.

The division in the length direction L of the ceramic element body 2 will be described. The ceramic element body 2 can be divided into a first-end-surface-side outer layer portion 13, a length-direction opposing portion 14, and a second-end-surface-side outer layer portion 15.

The length-direction opposing portion 14 is a portion in which an inner electrode layer 30 opposes an inner electrode layer 30 in the height direction T. The first-end-surface-side outer layer portion 13 is a portion between the length-direction opposing portion 14 and the first end surface 7. The second-end-surface-side outer layer portion 15 is a portion between the length-direction opposing portion 14 and the second end surface 8.

The length-direction opposing portion 14 is a portion corresponding to an opposing electrode portion of the inner electrode layer 30. The first-end-surface-side outer layer portion 13 and the second-end-surface-side outer layer portion 15 are portions corresponding to an extended electrode portion of the inner electrode layer 30. The first-end-surface-side outer layer portion 13 or the second-end-surface-side outer layer portion 15 is also referred to as an L gap.

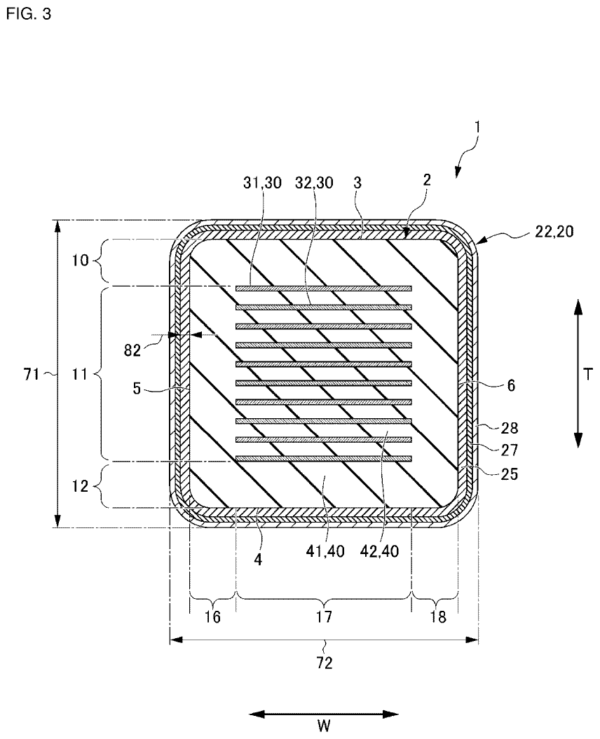

The division in the width direction W of the ceramic element body 2 will be described with reference to FIG. 3. FIG. 3 is a sectional view of the cross section taken along line II-II in FIG. 1. The ceramic element body 2 can be divided into a first-side-surface-side outer layer portion 16, a width-direction opposing portion 17, and a second-side-surface-side outer layer portion 18 in the width direction W.

The width-direction opposing portion 17 is a portion in which an inner electrode layer 30 opposes an inner electrode layer 30 in the height direction T. The first-side-surface-side outer layer portion 16 is a portion between the width-direction opposing portion 17 and the first side surface 5. The second-side-surface-side outer layer portion 18 is a portion between the width-direction opposing portion 17 and the second side surface 6.

The first-side-surface-side outer layer portion 16 and the second-side-surface-side outer layer portion 18 are portions in which the inner electrode layer 30 is not present in the height direction T. The first-side-surface-side outer layer portion 16 or the second-side-surface-side outer layer portion 18 is also referred to as a W gap.

### Inner Electrode Layer

The inner electrode layers 30 include a plurality of first inner electrode layers 31 and a plurality of second inner electrode layers 32. The first inner electrode layer 31 is the inner electrode layer 30 exposed at the first end surface 7. The second inner electrode layer 32 is the inner electrode layer 30 exposed at the second end surface 8.

The first inner electrode layer 31 can be divided into a first opposing electrode portion 34 and a first extended electrode portion 36. The first opposing electrode portion 34 is a portion opposing the second inner electrode layer 32. The first extended electrode portion 36 is a portion extended from the first opposing electrode portion 34 to the first end surface 7.

The second inner electrode layer 32 can be divided into a second opposing electrode portion 35 and a second extended electrode portion 37. The second opposing electrode portion 35 is a portion opposing the first inner electrode layer 31. The second extended electrode portion 37 is a portion extended from the second opposing electrode portion 35 to the second end surface 8.

The material for forming the inner electrode layer 30 is at least one of metals, such as nickel, copper, silver, palladium, and gold, and alloys, such as a silver-palladium alloy, including at least one of the above-described metals.

In the multilayer ceramic capacitor 1, capacitance is generated due to the first opposing electrode portion 34 opposing the second opposing electrode portion 35 with an inner-layer dielectric layer 42 interposed therebetween. Consequently, the multilayer ceramic capacitor 1 realizes characteristics of a capacitor.

The thickness of the inner electrode layer 30 is preferably about 0.2 μm or more and about 2.0 μm or less, for example. The total number of the number of the first inner electrode layers 31 and the number of the second inner electrode layers 32 is preferably 15 or more and 2,000 or less, for example.

### Terminal Electrode

The terminal electrode 20 will be described. The terminal electrode 20 includes a first terminal electrode 21 and a second terminal electrode 22. The first terminal electrode 21 is the terminal electrode 20 connected to the first inner electrode layer 31. The second terminal electrode 22 is the terminal electrode 20 connected to the second inner electrode layer 32.

The first terminal electrode 21 is arranged on the first end surface 7, a portion of the first principal surface 3, a portion of the second principal surface 4, a portion of the first side surface 5, and a portion of the second side surface 6. The second terminal electrode 22 is arranged on the second end surface 8, a portion of the first principal surface 3, a portion of the second principal surface 4, a portion of the first side surface 5, and a portion of the second side surface 6.

The terminal electrode 20 includes an outer electrode 25, a nickel plating film 27, and a tin plating film 28. The outer electrode 25, the nickel plating film 27, and the tin plating film 28 are arranged in the order of the outer electrode 25, the nickel plating film 27, and the tin plating film 28 from the end surface of the ceramic element body 2.

### Outer Electrode

The outer electrode 25 is arranged on the end surface of the ceramic element body 2 and covers the end surface. The outer electrode 25 extends from the end surface to a portion of the principal surface and a portion of the side surface.

The outer electrode 25 includes glass and metal. The outer electrode 25 includes an electrode paste including glass and metal being applied to the ceramic element body 2 and being fired. The metal includes copper. The metal in the form of a metal powder is included in the electrode paste. The glass includes barium-boron-silicon-based glass. The glass in the form of a glass powder is included in the electrode paste. The glass improves close contact between the ceramic element body 2 and the outer electrode 25. The thickness of the outer electrode 25 is preferably about 3 μm or more and about 20 μm or less, for example.

In this regard, the glass is not limited to the barium-boron-silicon-based glass. The glass can be at least one of barium-boron-silicon-based glass, strontium-boron-silicon-based glass, or barium-strontium-boron-silicon-based glass.

The electrode paste may be formed by mixing a glass powder of the barium-boron-silicon-based glass and a glass powder of the strontium-boron-silicon-based glass. Consequently, both components of a barium component and a strontium component can be added to the outer electrode 25.

The thickness of the thickest portion of the outer electrode 25 formed on the first end surface 7 or the second end surface 8 is preferably about 15 μm or less, for example. In addition, the thickness of the thickest portion of the outer electrode 25 formed on the first side surface 5 or the second side surface 6 is preferably about 5 μm or less, for example.

### Plating Film

The nickel plating film 27 is arranged so as to cover the outer electrode 25. The tin plating film 28 is arranged so as to cover the nickel plating film 27.

The thickness of the nickel plating film 27 is preferably about 2 μm or more and about 5 μm or less, for example. The thickness of the tin plating film 28 is preferably about 3 μm or more and about 5 μm or less, for example.

The nickel plating film 27 prevents the outer electrode 25 from being eroded by the solder when the multilayer ceramic capacitor 1 is mounted. The tin plating film 28 improves the wettability of the solder so as to facilitate the mounting when the multilayer ceramic capacitor 1 is mounted.

In this regard, the terminal electrode 20 may include only one of the nickel plating film 27 and the tin plating film 28.

The length in the length direction L of the multilayer ceramic capacitor 1 including the ceramic element body 2 and the terminal electrode 20 is indicated by a length 70 in FIG. 2. The length in the height direction T of the multilayer ceramic capacitor 1 including the ceramic element body 2 and the terminal electrode 20 is indicated by a length 71 in FIG. 2 and FIG. 3. The length in the width direction W of the multilayer ceramic capacitor 1 including the ceramic element body 2 and the terminal electrode 20 is indicated by a length 72 in FIG. 3.

The length 70 is preferably about 10 mm or less and more preferably about 0.6 mm or less, for example. The length 71 and the length 72 are preferably about 5 mm or less and more preferably about 0.3 mm or less, for example.

### Sulfur-Including Layer and Tin Layer

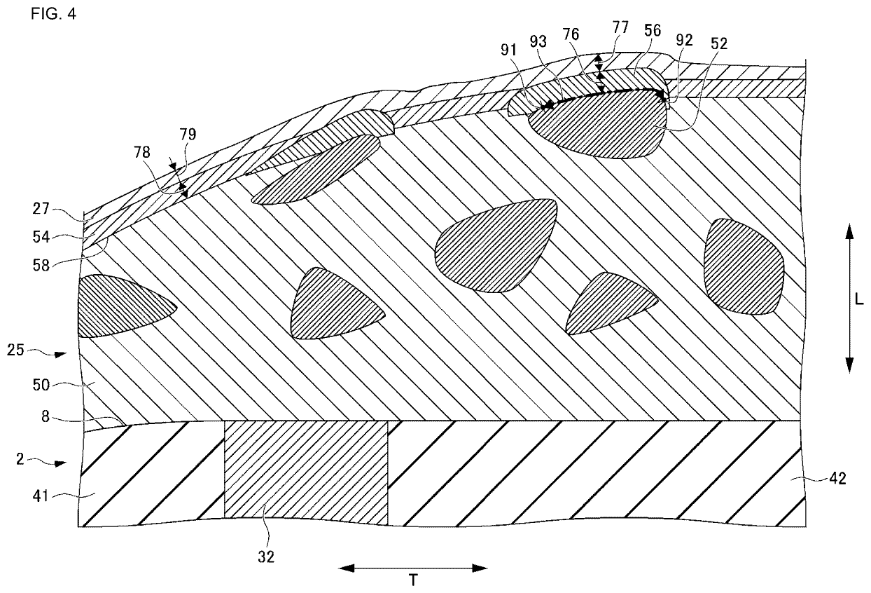

The outer electrode 25 according to the present example embodiment will be described in more detail. FIG. 4 is an enlarged view of a box 68 in FIG. 2. FIG. 4 illustrates an enlarged LT cross section of a portion of the outer electrode 25. The outer electrode 25 includes copper 50 and barium-boron-silicon-based glass 52. The barium-boron-silicon-based glass 52 has the shape of a particle. The barium-boron-silicon-based glass 52 in the form of a particle is dispersed in the copper 50. The copper 50 and the barium-boron-silicon-based glass 52 are exposed at the surface 58 of the outer electrode 25.

Regarding the outer electrode 25 according to the present example embodiment, a sulfur-including layer 56 is formed on the surface of the barium-boron-silicon-based glass 52 exposed at the surface 58 of the outer electrode 25. In addition, a tin layer 54 is formed on the surface of the copper 50 exposed at the surface 58 of the outer electrode 25. The nickel plating film 27 is formed on the surface on which the sulfur-including layer 56 or the tin layer 54 is not formed, the surface of the sulfur-including layer 56 formed on the surface 58 of the outer electrode 25, and the surface of the tin layer 54 formed on the surface 58 of the outer electrode 25 regarding the surface 58 of the outer electrode 25. In this regard, the sulfur-including layer 56 may be formed on at least a portion of the surface of the barium-boron-silicon-based glass 52 exposed at the surface 58 of the outer electrode 25.

In addition, the tin layer 54 may be formed on at least a portion of the surface of the copper 50 exposed at the surface 58 of the outer electrode 25.

In the present example embodiment, the sulfur-including layer 56 is present on the surface of the barium-boron-silicon-based glass 52 exposed at the surface 58. Consequently, when the plating film is formed, moisture can be prevented from entering the interior of the outer electrode 25 from the surface 58 of the outer electrode 25 with the barium-boron-silicon-based glass 52 interposed therebetween.

In the present example embodiment, the tin layer 54 is present on the surface of the copper 50 exposed at the surface 58. Consequently, when the plating film is formed, a hydrogen atom can be prevented from diffusing from the surface 58 of the outer electrode 25 into the interior of the outer electrode 25 with the copper 50 interposed therebetween.

The moisture being prevented from entering and the hydrogen atom being prevented from diffusing improve the reliability of the multilayer ceramic capacitor 1. In particular, even when the film thickness of the outer electrode 25 is decreased, sufficient moisture resistance reliability can be ensured.

The thickness of the sulfur-including layer 56 and the thickness of the tin layer 54 will be described. The thickness of the sulfur-including layer 56 is indicated by a thickness 76 in FIG. 4. The thickness of the portion of the nickel plating film 27 in contact with the sulfur-including layer 56 is indicated by a thickness 77. The thickness of the tin layer 54 is indicated by a thickness 78. The thickness of the portion of the nickel plating film 27 in contact with the tin layer 54 is indicated by a thickness 79.

The thickness ratio of the sulfur-including layer 56 to the portion of the nickel plating film 27 in contact with the sulfur-including layer 56 is preferably about 0.07 or more and about 0.56 or less, for example. In addition, the thickness ratio of the tin layer 54 to the portion of the nickel plating film 27 in contact with the tin layer 54 is preferably about 0.07 or more and about 0.56 or less, for example.

The thickness ratio of the sulfur-including layer 56 to the nickel plating film 27 being about 0.07 or more and about 0.56 or less, for example, more reliably prevents moisture from entering the interior of the outer electrode 25 from the surface 58 of the outer electrode 25 with the barium-boron-silicon-based glass 52 interposed therebetween when the plating film is formed.

In addition, the thickness ratio of the tin layer 54 to the nickel plating film 27 being about 0.07 or more and about 0.56 or less, for example, more reliably prevents a hydrogen atom from diffusing from the surface 58 of the outer electrode 25 into the interior of the outer electrode 25 with the copper 50 interposed therebetween when the plating film is formed.

The thickness 76 of the sulfur-including layer 56 is preferably about 0.14 μm or more and about 2.80 μm or less, for example. The thickness 78 of the tin layer 54 is preferably about 0.14 μm or more and about 2.80 μm or less, for example.

The thickness 77 and the thickness 79 of the nickel plating film 27 are preferably about 2 μm or more and about 5 μm or less, for example.

In this regard, the thickness of each of the thickness 76 to thickness 79 is measured by observing the cross section of the relevant location.

The length 70 in the length direction L of the multilayer ceramic capacitor 1 is preferably about 0.6 mm or less, for example. Each of the length 71 in the height direction T and the length 72 in the width direction W of the multilayer ceramic capacitor 1 is preferably about 0.3 mm or less, for example. The thickness of the thickest portion of the outer electrode 25 is preferably about 20 μm or less, for example.

The thickness of the outer electrode 25 formed on the first end surface 7 is indicated by a thickness 80 in FIG. 2. The thickness of the outer electrode 25 formed on the first side surface 5 is indicated by a thickness 82 in FIG. 3.

The thickness of the thickest portion of the outer electrode 25 formed on the first end surface 7 or the second end surface 8 is preferably about 15 μm or less, for example. The thickness of the thickest portion of the outer electrode 25 formed on the first side surface 5 or the second side surface 6 is preferably about 5 μm or less, for example.

Even when the thickness of the thickest portion of the outer electrode 25 formed on the principal surface, the side surface, and the end surface of the ceramic element body 2 is about 20 μm or less, for example, the multilayer ceramic capacitor 1 according to the present example embodiment can ensure reliability due to the tin layer 54 and the sulfur-including layer 56 being formed.

Regarding a small multilayer ceramic capacitor 1 such as the multilayer ceramic capacitor 1 having the length 70 in the length direction L of about 0.6 mm or less and each of the length 71 in the height direction T and the length 72 in the width direction W of about 0.3 mm or less, for example, the thickness of the outer electrode 25 is decreased. Regarding the thickness of the outer electrode 25, the thickness of the thickest portion of the outer electrode 25 may be about 20 μm or less, for example. In the multilayer ceramic capacitor 1 according to the present example embodiment, the tin layer 54 and the sulfur-including layer 56 are formed. Therefore, even when the multilayer ceramic capacitor 1 is reduced in size and the thickness of the outer electrode 25 is decreased, the reliability can be prevented from deteriorating.

In particular, even when the thickness of the thickest portion of the outer electrode 25 formed on the first end surface 7 or the second end surface 8 is about 15 μm or less and the thickness of the thickest portion of the outer electrode 25 formed on the first side surface 5 or the second side surface 6 is about 15 μm or less, for example, the reliability can be prevented from deteriorating.

### Formation of Sulfur-Including Layer 56

Formation of the sulfur-including layer 56 will be described. Examples of the sulfur-including layer 56 include a layer including barium sulfate. A barium source of the barium sulfate is the barium-boron-silicon-based glass 52 included as glass in the outer electrode 25.

The ceramic element body 2 provided with the outer electrode 25 and provided with no plating film is immersed in an aqueous solution to which sulfuric acid is added. When the ceramic element body 2 is immersed in the sulfuric acid aqueous solution, barium oxide included in the barium-boron-silicon-based glass 52 reacts with sulfuric acid. As a result, barium sulfate is formed on the surface of the barium-boron-silicon-based glass 52. The barium sulfate is a poorly soluble salt.

The sulfur-including layer 56 is formed on the surface of the barium-boron-silicon-based glass 52 exposed at the surface 58 of the outer electrode 25. The reason for this is that sulfuric acid comes into contact with the surface of the barium-boron-silicon-based glass 52 exposed at the surface 58 of the outer electrode 25.

### Formation of Tin Layer 54

Formation of the tin layer 54 will be described. The tin layer 54 is formed due to occurrence of a substitution reaction between the nickel plating and the tin medium and redeposition of the eluted tin ion on copper. Formation of the tin layer 54 can be performed by using a barrel plating device or the like.

The ceramic element body 2 provided with the outer electrode 25 and provided with no plating film and a medium including tin are placed in the barrel plating device. Thereafter, the tin layer 54 can be formed by performing agitation without energization.

### Examples and Comparative Examples

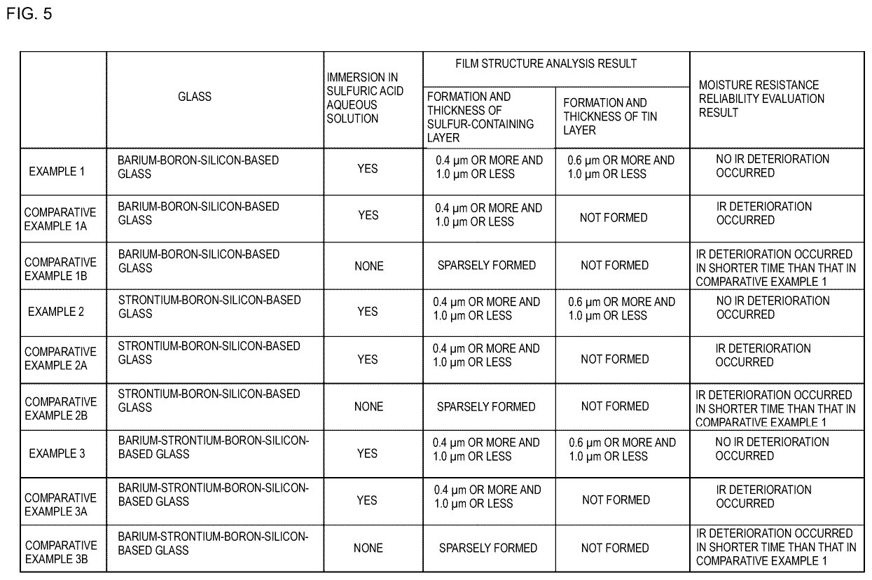

Examples and Comparative examples will be described. FIG. 5 illustrates the evaluation results of Examples and Comparative examples. The ceramic element body 2 in Comparative example was the same as that in Example. In the ceramic element body 2, nickel inner electrodes were exposed at the two end surfaces alternately. The ceramic element body 2 had a length in the length direction L of about 0.4 mm, a length in the height direction T of about 0.2 mm, and a length in the width direction W of about 0.2 mm, for example.

An electrode paste serving as an example of the outer electrode 25 was produced by kneading the following raw materials by using a roll mill. The glass powders were three types of barium-boron-silicon-based glass, strontium-boron-silicon-based glass, and barium-strontium-boron-silicon-based glass.
4-μm-diameter flat copper powder: 67.8% by weight
Glass (powder): 8.3% by weight
Acrylic resin: 6.6% by weight
Terpineol: 17.3% by weight

As illustrated in FIG. 5, the glass in Example 1, Comparative example 1A, and Comparative example 1B is the barium-boron-silicon-based glass. The glass in Example 2, Comparative example 2A, and Comparative example 2B is the strontium-boron-silicon-based glass. The glass in Example 3, Comparative example 3A, and Comparative example 3B is barium-strontium-boron-silicon-based glass.

The electrode paste was applied to the ceramic element body 2, and the applied electrode paste was fired. Initially, one end surface of the ceramic element body 2 was immersed in the electrode paste. Thereafter, drying was performed at about 100° C. for about 10 min, for example. Subsequently, in the same way, the other end surface was immersed in the electrode paste and dried. Subsequently, the electrode paste was fired at 800 degrees in a nitrogen gas. Consequently, a chip provided with the outer electrode 25 was obtained.

In the Example, the obtained chip and a tin material medium were placed together in an electrolytic plating barrel. The electrolytic plating barrel was immersed in a sulfate-ion-including nickel plating bath, and agitation was performed without energization. The plating bath was set to be a Watts bath. Barium sulfate was formed on the glass surface layer by this treatment. The barium sulfate was the sulfur-including layer 56.

In addition, this treatment caused a substitution reaction between the nickel plating and the tin medium and redeposited the eluted tin on the copper surface layer. The tin was derived from the medium. The deposited tin was the tin layer 54.

Comparative examples 1A, 2A, and 3A differed from Comparative examples 1B, 2B, and 3B in presence or absence of immersion of the chip in the sulfuric acid aqueous solution. In Comparative examples 1A, 2A, and 3A, the chip was immersed in the sulfuric acid aqueous solution. In Comparative examples 1B, 2B, and 3B, the chip was not immersed in the sulfuric acid aqueous solution.

In Comparative examples 1A, 2A, and 3A, the obtained chip was immersed in a 5×10⁻⁵ mol/L sulfuric acid aqueous solution, and agitation was performed for 3 min. Barium sulfate was formed on the glass surface layer by this treatment.

Subsequently, in all Examples and Comparative examples, plating films were formed. The plating films were formed in the order of the nickel plating film 27 and the tin plating film 28. The nickel plating film 27 was formed under the following conditions.
Type of plating bath: Watts bath
pH of plating bath: 4.0
Bath temperature of plating bath: 60 degrees
current value: 6 A
Plating time: 51 min

The tin plating film 28 was formed under the following conditions.

Type of plating bath: neutral plating bath
pH of plating bath: 6.0
Bath temperature of plating bath: 25 degrees
current value: 3 A
Plating time: 66 min

### Moisture Resistance Reliability Evaluation

Regarding the formed sample in Examples and Comparative examples, the moisture resistance reliability evaluation and the film structure analysis were performed. The moisture resistance reliability evaluation will be described. The moisture resistance reliability evaluation was performed by a PCBT test. The conditions of the PCBT (Pressure-Cooker-Bias Test) test were as described below.
Temperature: 125 degrees
Relative humidity: 95%
Applied voltage: 3.2 V
Loading time: 72 hours
Number of samples: 15

After the PCBT test, the insulation resistance (IR) of each sample was measured. When a Log IR value at the finish of the PCBT test was 0.5 or more lower than that at the start, it was rated that IR deterioration occurred.

Regarding the samples in Examples 1 to 3, IR deterioration was not observed. Regarding the samples in Comparative examples 1A to 3A and Comparative examples 1B to 3B, IR deterioration was observed. In addition, the time in which IR deterioration was assumed to occur in Comparative examples 1B to 3B was shorter than the time in which IR deterioration was assumed to occur in Comparative examples 1A to 3A.

### Film Structure Analysis

The film structure analysis will be described. The sample was embedded in a resin, and grinding was performed so as to expose a cross section. Thereafter, the ground surface was subjected to processing five times by using a high-performance focused ion beam (FIB) device (SMI-3050R produced by Hitachi High-Tech Corporation). The cross section was set to be the cross section at the position of the box 68 in FIG. 2.

Subsequently, platinum coating was performed for 30 sec, and element mapping was performed by using a field emission electron probe microanalyzer (FE-WDX) (JXA-8530F produced by JEOL LTD.) under the following conditions.
Accelerating voltage: 15 kV
Probe current: 50 nA
Number of pixels: 256×256
Pixel size: 0.24 μm
Dwell Time: 40 ms

The following were ascertained from the element mapping image. Regarding the samples in Examples 1 to 3, a sulfur-including layer having a thickness of 0.4 μm or more and 1.0 μm or less was formed on glass of the surface 58 of the outer electrode 25. A tin layer 54 having a thickness of 0.6 μm or more and 1.0 μm or less was formed on copper of the surface 58 of the outer electrode 25.

Regarding the samples in Comparative examples 1A to 3A, the sulfur-including layer 56 having a thickness of 0.4 μm or more and 1.0 μm or less was formed on glass of the surface 58 of the outer electrode 25. The tin layer 54 was not formed on copper of the surface 58 of the outer electrode 25.

Regarding the samples in Comparative examples 1B to 3B, the sulfur-including layer 56 was sparsely formed on glass of the surface 58 of the outer electrode 25. The tin layer 54 was not formed on copper of the surface 58 of the outer electrode 25.

Regarding the samples in Examples 1 to 3, the sulfur-including layer 56 being formed on glass prevented moisture from entering the outer electrode 25 through the glass portion serving as a route. In addition, the tin layer 54 being formed on copper prevented a hydrogen atom from diffusing into the outer electrode 25 through the copper portion serving as a route. Consequently, in Comparative examples 1A to 3A, the moisture resistance reliability was ensured.

Regarding the samples in Comparative examples 1A to 3A, the sulfur-including layer 56 was formed, but the tin layer 54 was not formed. Consequently, the moisture resistance reliability was not sufficiently ensured.

Regarding the samples in Comparative examples 1B to 3B, the tin layer 54 was not formed, and the sulfur-including layer 56 was only sparsely formed. When the nickel plating film was formed, the sulfur-including layer was slightly formed on the glass. However, the formation was insufficient for preventing moisture from entering the outer electrode 25. Further, since the tin layer 54 was not formed on the copper, the moisture resistance reliability was significantly low.

In the LT cross section in FIG. 4, one end of the surface of the barium-boron-silicon-based glass 52 exposed at the surface 58 of the outer electrode 25 is indicated by a point 91, and the other end is indicated by a point 92. The length from the point 91 to the point 92 of the surface of the barium-boron-silicon-based glass 52 exposed at the surface 58 of the outer electrode 25 is indicated by a length 93.

The proportion of the length of the sulfur-including layer 56 in contact with the barium-boron-silicon-based glass 52 in the length 93 is set to be sulfur coverage. The sulfur coverage is preferably about 67.0% or more, for example.

### Measuring Method

The method for measuring the length and the thickness of each portion when the measuring method is not particularly specified will be described. The multilayer ceramic capacitor 1 is ground up to a central position in the width direction W. Subsequently, the LT cross section exposed by grinding is observed by using an optical microscope. Regarding the observed LT cross section, the length or the thickness is measured.

### Method for Manufacturing Multilayer Ceramic Capacitor

A non-limiting example of a method for manufacturing the multilayer ceramic capacitor 1 will be described. Initially, a dielectric sheet serving as the dielectric layer 40 and a conductive paste serving as the inner electrode layer 30 are prepared. The dielectric sheet and the conductive paste include a binder and a solvent. The binder and the solvent may be a known organic binder, organic solvent, and the like.

The conductive paste having a predetermined pattern is applied to the dielectric sheet. The pattern of the inner electrode layer 30 is formed by the conductive paste being applied. The application is performed by screen printing, gravure printing, or the like.

A predetermined number of dielectric sheets serving as the outer layer portion are stacked. The dielectric sheets serving as the outer layer portion are not printed with the conductive paste. A predetermined number of dielectric sheets printed with the pattern of the inner electrode layer 30 are stacked on the stacked dielectric sheets. A predetermined number of dielectric sheets serving as the outer layer portion are stacked thereon. A multilayer sheet is produced by the stacking described above.

The number of stacked dielectric sheets is preferably 15 or more and 2,000 or less, for example. The thickness of a dielectric sheet is preferably about 0.3 μm or more and about 10 μm or less, for example.

The multilayer sheet is pressed in the height direction so as to produce a multilayer block. The pressing method uses isostatic press.

The multilayer block is cut into a predetermined size. A multilayer chip is cut out by the cutting. When the cutting is performed, the corner portion and the ridge portion of the multilayer chip may be provided with roundness. A method for providing roundness is barrel polishing.

The multilayer chip is fired. A ceramic element body is produced by the firing. The firing temperature is preferably about 900 degrees or higher and about 1, 110 degrees or lower, for example. The firing temperature can be changed in accordance with the material for forming the dielectric layer 40 and the material for forming the inner electrode layer 30.

Next, the terminal electrode 20 is formed. Initially, an electrode paste serving as the outer electrode 25 is applied to two end surfaces of the ceramic element body 2. The electrode paste includes glass, metal, and the like. Application of the electrode paste is performed by using a method such as dipping. Firing is performed after the application so as to form the outer electrode 25. The firing temperature is preferably about 500 degrees or higher and about 900 degrees or lower, for example. In addition, the firing time is preferably about 30 min or more and about 2 hours or less, for example.

The nickel plating film 27 is formed on the surface of the outer electrode 25. Further, the tin plating film 28 is formed on the surface of the nickel plating film 27. The nickel plating film 27 and the tin plating film 28 are formed by a barrel plating method.

When the nickel plating film 27 is formed, a tin material medium is introduced. Subsequently, agitation was performed without energization in a barrel plating bath. Consequently, the tin layer 54 is formed.

Thereafter, the nickel plating film 27 can be formed by performing energization barrel plating.

The sulfur-including layer 56 is formed during the above-described agitation without energization in the barrel plating bath and agitation with energization.

In this regard, the bath for the above-described agitation without energization can be changed from that for the agitation with energization. For example, in the step of forming the tin layer 54, a bath in which the tin material medium is introduced is used. In the step of forming the nickel plating film 27, the Watts bath in which the tin material medium is not introduced is used.

Consequently, the multilayer ceramic capacitor 1 is produced.

The example embodiments according to the present invention have been described above. The present invention is not limited to the above-described example embodiments, and can be variously changed and modified.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic element body including a plurality of stacked dielectric layers and a plurality of stacked inner electrode layers and including six surfaces including a first principal surface and a second principal surface that oppose each other in a height direction, a first side surface and a second side surface that oppose each other in a width direction orthogonal to the height direction, and a first end surface and a second end surface that oppose each other in a length direction orthogonal to the height direction and the width direction; and
an outer electrode on the ceramic element body and connected to a portion of the inner electrode layers; wherein
the outer electrode includes at least one of barium-boron-silicon-based glass, strontium-boron-silicon-based glass, or barium-strontium-boron-silicon-based glass, which serves as glass and copper;
the glass and the copper are exposed at a surface of the outer electrode;
a sulfur-including layer is provided on at least a portion of a surface of the glass exposed at the surface of the outer electrode; and
a tin layer is provided on at least a portion of a surface of the copper exposed at the surface of the outer electrode.

2. The multilayer ceramic capacitor according to claim 1, wherein
a nickel plating film is provided on:
a surface of the outer electrode on which neither the sulfur-including layer nor the tin layer is located;
a surface of the sulfur-including layer on the surface of the outer electrode; and
a surface of the tin layer on the surface of the outer electrode; and
each of a thickness ratio of the sulfur-including layer to a portion of the nickel plating film in contact with the sulfur-including layer and a thickness ratio of a thickness of the tin layer to a portion of the nickel plating film in contact with the tin layer is about 0.07 or more and about 0.56 or less.

3. The multilayer ceramic capacitor according to claim 1, wherein
a dimension in the length direction is about 0.6 mm or less;
each of a dimension in the height direction and a dimension in the width direction is about 0.3 mm or less; and
a thickness of a thickest portion of the outer electrode is about 20 μm or less.

4. The multilayer ceramic capacitor according to claim 1, wherein
a thickness of a thickest portion of the outer electrode on the first end surface or the second end surface is about 15 μm or less; and
a thickness of a thickest portion of the outer electrode on the first side surface or the second side surface is about 5 μm or less.

5. The multilayer ceramic capacitor according to claim 1, wherein the ceramic element body has a rectangular or substantially rectangular shape.

6. The multilayer ceramic capacitor according to claim 1, wherein the ceramic element body includes rounded corner portions and ridge portions.

7. The multilayer ceramic capacitor according to claim 1, wherein each of the inner electrode layers has a thickness of about 0.2 μm or more and about 2.0 μm or less.

8. The multilayer ceramic capacitor according to claim 1, wherein a total number of the inner electrode layers included in the ceramic element body is 15 or more and 2,000 or less.

9. The multilayer ceramic capacitor according to claim 1, wherein a thickness of the outer electrode is about 3 μm or more and about 20 μm or less.

10. The multilayer ceramic capacitor according to claim 1, wherein a thickness of the thickest portion of the outer electrode located on the first end surface or the second end surface is about 15 μm or less.

11. The multilayer ceramic capacitor according to claim 1, wherein a thickness of the thickest portion of the outer electrode located on the first side surface or the second side surface is about 5 μm or less.

12. The multilayer ceramic capacitor according to claim 2, wherein a thickness of the nickel plating film is about 2 μm or more and about 5 μm or less.

13. The multilayer ceramic capacitor according to claim 2, further comprising a tin plating film located on the nickel plating film.

14. The multilayer ceramic capacitor according to claim 13, wherein a thickness of the tin plating film is about 3 μm or more and about 5 μm or less.

15. The multilayer ceramic capacitor according to claim 1, wherein a thickness of the sulfur-including layer is about 0.14 μm or more and about 2.80 μm or less.

16. The multilayer ceramic capacitor according to claim 1, wherein a thickness of the tin layer is about 0.14 μm or more and about 2.80 μm or less.

17. The multilayer ceramic capacitor according to claim 2, wherein a thickness of the nickel plating film is about 2 μm or more and about 5 μm or less.
